(19) United States
(12) Patent Application Publication
(10) Pub. No.: US 2026/0140496 A1
(43) Pub. Date: May 21, 2026

(54) DEVICE AND METHOD FOR CHECKING LINEAGE OF DATA WITH LARGE LANGUAGE MODEL TO LOCATE ABNORMALITIES

(71) Applicants: SQ Technology (Shanghai) Corporation, Shanghai (CN); Inventec Corporation, Taipei City (TW)

(72) Inventor: Yun Hao, Shanghai (CN)

(21) Appl. No.: 19/027,898

(22) Filed: Jan. 17, 2025

(30) Foreign Application Priority Data
Nov. 21, 2024 (CN) 2024116806721

(51) Int. Cl. G05B 19/418; G06F 40/205

(52) U.S. Cl. CPC G05B 19/41875; G06F 40/205

(57) ABSTRACT

A device of checking lineage of data with a large language model to locate abnormalities and a corresponding method are disclosed. A large language model is used to parse an abnormality location request in natural language to obtain field information of target data occurring abnormality. Lineage data of the target data is obtained based on the field information to generate discrepancy information indicating upstream data and/or service where the abnormality has occurred, and the large language model outputs an abnormality locating result including the discrepancy information in natural language, thereby reducing complexity of inspection process, professional needs of personnel, and inspection time, and achieving the technical effect of improving inspection efficiency and accuracy and user satisfaction.

### CROSS-REFERENCE TO RELATED APPLICATION

This application claims the benefit of Chinese Application Serial No. 2024116806721, filed Nov. 21, 2024, which is hereby incorporated herein by reference in its entirety.

### BACKGROUND OF THE INVENTION

### 1. Field of the Invention

The present invention relates to device and method for abnormal data detection, and particularly to device and method of checking lineage of data with a large language model to locate abnormalities.

### 2. Description of the Related Art

Industry 4.0, also known as the fourth industrial revolution, is about creating new industrial technologies and focuses on integrating existing industrial technologies, sales processes, and product experiences. Industry 4.0 establishes smart factories with adaptability, resource efficiency, and ergonomics through artificial intelligence technology, and integrates customers and business partners into business and value processes to provide comprehensive after-sales services, thereby constructing a new smart industrial world with perceptual awareness.

As the wave of Industry 4.0 sweeps across the globe, manufacturers are optimizing production and transformation through smart manufacturing to enhance competitiveness. Smart manufacturing is built upon sensing technology, network technology, automation technology, and artificial intelligence to achieve intelligent product design and manufacturing, enterprise management, and services through processes of perception, human-machine interaction, decision-making, execution and feedback.

The electronics assembly industry, characterized by low profit margins and fierce price competition, drives businesses to pursue effective control and optimization of raw materials and production tools to maximize factory resource efficiency. To manage a production line in the electronics assembly industry effectively, production line engineers often monitor visual dashboards on the production line to understand an order completion status and must notify maintenance personnel when data abnormality is found on the visual boards.

Upon receiving notifications from production line engineers, maintenance personnel typically need to conduct a series of complex check operations, including data source check, Extract, Transform, and Load (ETL process troubleshooting), data quality validation, upstream and downstream data flow analysis, debugging and verification. The data source check is to determine whether data sources operate normally and whether there is any data loss or error. The ETL process troubleshooting is to examine the extraction, transformation, load processes sequentially, and review data process logs and execution status at each step. The data quality validation is to check the integrity, accuracy, and consistency of the data. The upstream and downstream data flow analysis is to trace data flow paths to locate actual points of failure. The debugging and verification includes manually executing scripts and operations to verify the source of the issue.

However, the above check process requires checking multiple systems and tools, results in numerous and complex steps, and increases the time needed to locate the issue, so it causes low check efficiency and slow responses to user feedback and needs; furthermore, the check processes heavily rely on the experience and skills of maintenance personnel, so it may increase the risk of human error.

According to above-mentioned contents, what is needed is to develop an improved solution to solve the problem of high complexity, high time costs, low efficiency, and dependence on personnel experience in the abnormality check process on a production line.

### SUMMARY OF THE INVENTION

An objective of the present invention is to disclose a device of checking lineage of data with a large language model to locate abnormalities and a method thereof, to solve the problem of high complexity, high time costs, low efficiency, and dependence on personnel experience in the abnormality check process on a production line.

To achieve the objective, the present invention discloses a device of checking lineage of data with a large language model to locate abnormalities, and the device includes a request obtaining module, a large language model, a lineage tracking module and an abnormality locating module. The request obtaining module is configured to obtain an abnormality location request of target data. The large language model is configured to parse the abnormality location request to obtain a feature parameter, wherein the feature parameter includes field information of the target data. The lineage tracking module is configured to obtain lineage information of the target data based on the field information, and obtain lineage data based on the lineage information, wherein the lineage data includes upstream data and at least one service detection result. The abnormality locating module is configured to compare whether the upstream data matches the target data, and determine whether the service generating the upstream data is normal based on the service detection result, to generate discrepancy information, wherein the large language model generates and outputs an abnormality locating result, and the abnormality locating result includes the discrepancy information.

To achieve the objective, the present invention discloses a method of checking lineage of data with a large language model to locate abnormalities, include steps of: obtaining an abnormality location request of target data; using a large language model to parse the abnormality location request to obtain a feature parameter, wherein the feature parameter includes field information of the target data; obtaining lineage information of the target data based on the field information; obtaining lineage data based on the lineage information, wherein the lineage data includes upstream data and at least one service detection result; comparing whether the upstream data matches the target data, and determining whether a service generating the upstream data is normal based on the service detection result, to generate discrepancy information; outputting an abnormality locating result through the large language model, wherein the abnormality locating result includes the discrepancy information.

According to the above-mentioned device and method of the present invention, the difference between the present invention and the conventional technology is that, in the present invention, the large language model is used to parse the abnormality location request in natural language to obtain field information of target data occurring abnormality, lineage data of the target data is obtained based on the field information to generate discrepancy information indicating upstream data and/or service where abnormality occurs, and the large language model outputs the abnormality locating result including the discrepancy information in natural language, thereby solving the conventional problem and achieving the technical effect of improving inspection efficiency and accuracy and user satisfaction.

### BRIEF DESCRIPTION OF THE DRAWINGS

The structure, operating principle and effects of the present invention will be described in detail by way of various embodiments which are illustrated in the accompanying drawings.

FIG. 1 is a schematic view of a device of checking lineage of data with a large language model to locate abnormalities, according to the present invention.

FIG. 2 is a schematic view of modules of a processor, according to the present invention.

FIG. 3A is a flowchart of a method of checking lineage of data with a large language model to locate abnormalities, according to the present invention.

FIG. 3B is a flowchart of obtaining lineage data of target data, according to the present invention.

FIG. 3C is a flowchart of actively generating an abnormality location request, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

The concept of the present invention is to analyze a user-input description of detected abnormality through a large language model to obtain field information of abnormal data, track lineage data of the abnormal data to locate a part of the production line where the abnormality has occurred, and use the large language model to respond the part to the user. The above-mentioned description is usually a sentence in natural language. The part could involve data storage part occurring an error (such as errors in the media or system storing the data) or data processing part occurring an error (such as the data processing error occurs in conversion or calculation service), but the present invention is not limited to above-mentioned examples.

The lineage data of the present invention includes upstream data and a service detection result of a service generating the upstream data. More specifically, in the present invention, when the source data is processed to generate result data, the source data is referred to as the upstream data of the result data. It is noted that, in the present invention, the upstream data may also be another result data, in other words, when data A is generated by a service performing data processing on data B, and the data B is generated by another service performing data processing on data C, then the data B and the data C are both the upstream data of the data A, and so forth. Similarly, if another service performs data processing on the data D to generate the data C, then the data D is also the upstream data of the data A.

The device for implementing the concept of the present invention can be a computing apparatus. The computing apparatus mentioned in the present invention can include, but not limited to, one or more processing module, one or more memory module, and a bus connected to different hardware components including the memory module and the processing module. Through the hardware components, the computing apparatus can load and execute the operating system, so that the operating system runs on the computing apparatus and executes software or programs. In addition, the computing apparatus can include an outer shell, and the above-mentioned hardware component are disposed in the outer shell.

The bus mentioned in the present invention can include at least one type of bus, for example, the bus can include at least one of a data bus, an address bus, a control bus, an expansion bus, and a local bus. The bus of a computation device can include, but not limited to, a parallel bus such as an industry standard architecture (ISA) bus, a peripheral component interconnect (PCI) bus, a video electronics standards association (VESA) local bus, or a serial bus such as a USB, or a PCI express (PCI-E/PCIe) bus.

The processing module of the computing apparatus is coupled with the bus. The processing module includes a register group or a register space. The register group or the register space can be completely set on the processing chip of the processing module, or can be all or partially set outside the processing chip and is coupled to the processing chip through dedicated electrical connection and/or a bus. The processing module can be a central processing unit, a microprocessor, or any suitable processing component. If the computing apparatus is a multi-processor apparatus, that is, the computing apparatus includes processing modules, and the processing modules can be all the same or similar, and coupled and communicated with each other through a bus. The processing module can interpret a computer instruction or a series of multiple computer instructions to perform specific operations or operations, such as mathematical operations, logical operations, data comparison, data copy/moving, so as to drive other hardware component, execute the operating system, or execute various programs and/or module in the computing apparatus. The computer instructions can include assembly language instructions, instruction set architecture instructions, machine instructions, machine-related instructions, microinstructions, firmware instructions, or source code or object code written in one or more programming languages. The instructions can be executed entirely on a single computing apparatus, partially on a single computing apparatus, or partially on one computing apparatus and partially on another interconnected computing apparatus. The above-mentioned programming language can be, for example, object-oriented languages such as Common Lisp, Python, C++, Objective-C, Smalltalk, Delphi, Java, Swift, C #, Perl, Ruby, as well as procedural languages like C or similar languages.

The computing apparatus usually also includes one or more chipsets. The processing module of the computing apparatus can be coupled to the chipset, or electrically connected to the chipset through the bus. The chipset includes one or more integrated circuits (IC) including a memory controller and a peripheral input/output (I/O) controller, that is, the memory controller and the peripheral input/output controller can be implemented by one integrated circuit or implemented by two or more integrated circuits. Chipsets usually provide I/O and memory management functions, and multiple general-purpose and/or dedicated-purpose registers, timers. The above-mentioned general-purpose and/or dedicated-purpose registers and timers can be coupled to or electrically connected to one or more processing modules to the chipset for being accessed or used. In an embodiment, the chipset can be a part of the processing module.

The processing module of the computing apparatus can also access the data stored in the memory module and mass storage area installed on the computing apparatus through the memory controller. The above-mentioned memory modules include any type of volatile memory and/or non-volatile memory (NVRAM), such as Static Random Access Memory (SRAM), Dynamic Random Access Memory (DRAM), Read-Only Memory (ROM), or Flash memory. The above-mentioned mass storage area can include any type of storage device or storage medium, such as hard disk drives, optical discs, flash drives, memory cards, and solid state disks (SSD), or any other storage device. In other words, the memory controller can access data stored in static random access memory, dynamic random access memory, flash memory, hard disk drives, and solid state drives.

The processing module of the computing apparatus can also connect and communicate with peripheral devices and interfaces including peripheral output devices, peripheral input devices, communication interfaces, or data/signal receivers through the peripheral I/O controller and the peripheral I/O bus. The peripheral input device can be any type of input device, such as a keyboard, mouse, trackball, touchpad, or joystick. The peripheral output device can be any type of output device, such as a display, or a printer; the peripheral input device and the peripheral output device can also be the same device such as a touch screen. The communication interface can include a wireless communication interface and/or a wired communication interface. The wireless communication interface can include the interface capable of supporting wireless local area networks (such as Wi-Fi, Zigbee, etc.), Bluetooth, infrared, and near-field communication (NFC), 3G/4G/5G and other mobile communication network (cellular network) or other wireless data transmission protocol; the wired communication interface can be an Ethernet device, a DSL modem, a cable modem, an asynchronous transfer mode (ATM) devices, or optical fiber communication interfaces and/or components. The data/signal receiver can include a GPS receiver or physiological signal receiver. The physiological signals received by the physiological signal receiver include, but are not limited to, heartbeat, blood oxygen levels, and so on. The processing module can periodically poll various peripheral devices and interfaces, so that the computing apparatus can input and output data through various peripheral devices and interfaces and also communicate with another computing apparatus having the above-mentioned hardware components.

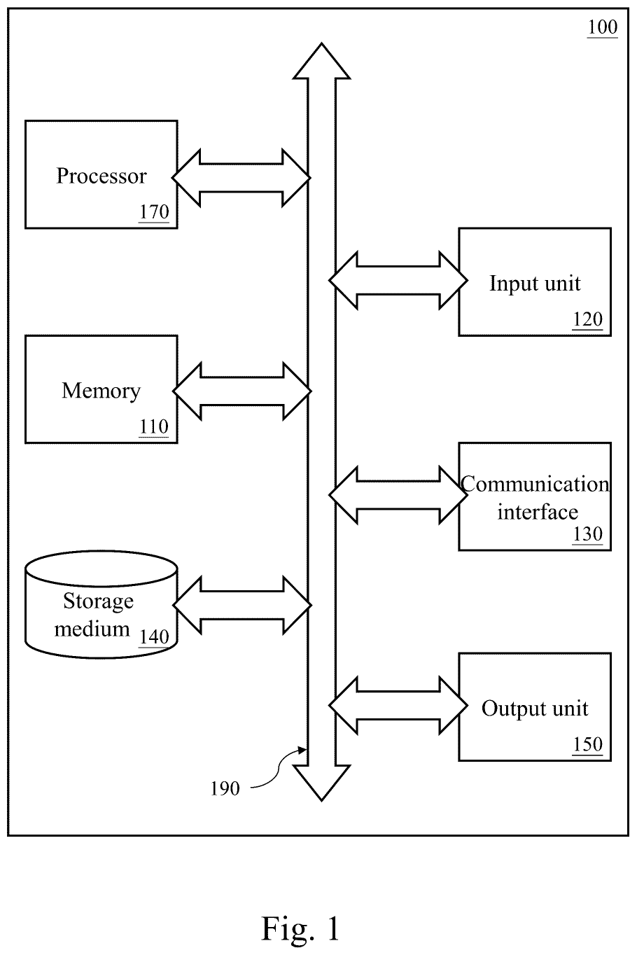

A device of the present invention will be illustrated in the following paragraphs with reference to FIG. 1, which is a schematic view of a device of checking lineage of data with a large language model to locate abnormalities, according to the present invention. As shown in FIG. 1, a device 100 can include a memory 110, an input unit 120, a communication interface 130, a storage medium 140, a processor 170, an output unit 150, and a bus 190. The processor 170 is connected to the memory 110, the input unit 120, the communication interface 130, the storage medium 140, and the output unit 150 via the bus 190.

The memory 110 is configured to store one or more sets of computer instructions.

The input unit 120 is configured to provide input data through a peripheral input device of the device 100. For example, the input unit 120 can provide input data through a keyboard, a mouse, a touchpad, or a touch screen.

The communication interface 130 is connected to a network device such as an external network storage device or a server, and requests and downloads data from the connected network device.

The storage medium 140 is configured to store data or signals downloaded by the communication interface 130, store data or signals required for the processor 170 operations, or store data or signals generated by the processor 170.

The output unit 150 is configured to output data generated by the processor 170 through the peripheral output device of the device 100. For example, the output unit 150 displays data via a monitor or touch screen.

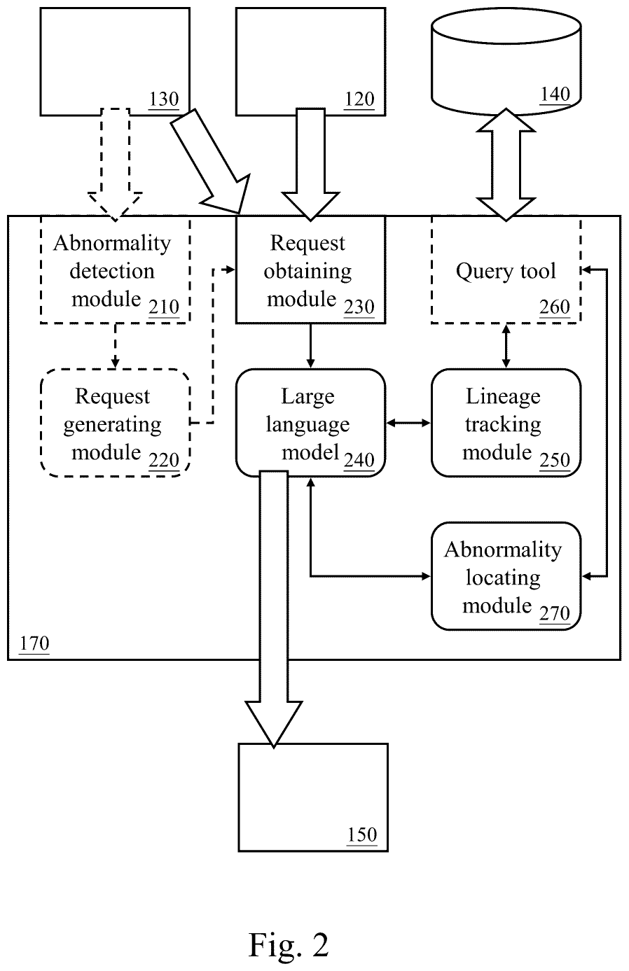

As shown in FIG. 2, the processor 170 includes a request obtaining module 230, a large language model 240, a lineage tracking module 250, an abnormality locating module 270; optionally, the processor 170 can include an abnormality detection module 210, a request generating module 220, and a query tool 260. In some embodiments, the processor 170 executes the computer instruction stored in the memory 110, and after executing computer instructions, the processor 170 can generate the modules shown in FIG. 2. In other embodiments, the modules in FIG. 2 can be implemented by one or more circuits and/or hardware components such as chips, that is, the processor 170 can include the hardware components forming the modules in FIG. 2, in other words, the modules in the processor 170 may be software or hardware modules, and the present invention does not have specific limitation in implementation for the modules.

The abnormality detection module 210 is configured to obtain a put-into production quantity and an actual production quantity of a production line. Generally, the abnormality detection module 210 obtains the put-into production quantity and the actual production quantity from the management device on the production line through the communication interface 130, but the present invention is not limited to this example. For example, the input unit 120 can be used to input the put-into production quantity and the actual production quantity.

The abnormality detection module 210 determines whether the put-into production quantity matches the actual production quantity. For example, the abnormality detection module 210 obtains a production ratio of the put-into production quantity to the actual production quantity of one or more components produced on the production line, and determines whether the put-into production quantity matches the actual production quantity based on the production ratio. However, the manner of the abnormality detection module 210 determining whether the put-into production quantity matches the actual production quantity is not limited to the above examples. The abnormality detection module 210 can read the production ratio from the storage medium 140 or download the production ratio from the management device on the production line through the communication interface 130, but the present invention does not have specific limitation in the modules.

When the abnormality detection module 210 determines that the put-into production quantity does not match the actual production quantity, the request generating module 220 generates the abnormality location request in which the actual production quantity and/or the put-into production quantity is used as the target data. For example, the request generating module 220 can use a name or identification data of the product produced on the production line, the name or the identification data of the site where the mismatch between the actual production quantity and the put-into production quantity occurs, the name or the identification data of the board where the mismatch between the actual production quantity and the put-into production quantity occurs, and the name or the identification data of the component which occurs mismatch between the actual production quantity and the put-into production quantity, and the mismatched actual production quantity and/or put-into production quantity as the target data, and the request generating module 220 can add the above-mentioned target data into the corresponding locations in a predefined natural language template to generate the abnormality location request in natural language; however, the present invention is not limited to above-mentioned examples. For example, the request generating module 220 can directly use the above-mentioned target data as the abnormality location request. The natural language in the natural language template can be correctly parsed by the large language model 240.

The request obtaining module 230 is configured to obtain the abnormality location request of the target data. Generally, the request obtaining module 230 can obtain the abnormality location request through the input unit 120 or the communication interface 130, but the present invention is not limited to above-mentioned examples. For example, the request obtaining module 230 can also obtain the abnormality location request generated by the request generating module 220.

The large language model 240 is configured to parse the abnormality location request obtained by the request obtaining module 230 to obtain the feature parameter. The feature parameter obtained by the large language model 240 includes the field information of the target data. The field information can include, but not limited to, a station name or identification data on the production line, a field name of the target data, etc. The large language model 240 is trained to understand key prompt words in the abnormality location request, such as technical terms, encoding rules for various identification data, a dashboard name of each dashboard, station names of stations, and field names of various data, to identify and extract the feature parameter from the abnormality location request. For example, when the abnormality location request is “the fixed asset number of SH0123456789 in a dashboard A is incorrect”, the large language model 240 identifies the product identification data as “SH0123456789”, the dashboard name as the “dashboard A”, and the target data as “the fixed asset number” from the abnormality location request. The large language model 240 can look up the field information corresponding to the fixed asset number field being “assettag” from a pre-built correspondence table, so that the large language model 240 can obtain feature parameters (such as the field information of product identification data, dashboard name, and target data) from the abnormality location request.

The large language model 240 is also configured to generate an abnormality locating result. The abnormality locating result generated by large language model 240 includes discrepancy information generated by the abnormality locating module 270. The large language model 240 outputs the generated abnormality locating result through the output unit 150, for example, by displaying or printing the abnormality locating result. Generally, the abnormality locating result is formed in natural language, in other words, the large language model 240 can generate the abnormality locating result expressing the discrepancy information in natural language, but the present invention is not limited to above-mentioned examples.

The lineage tracking module 250 is configured to obtain the lineage information of the target data based on the field information obtained by the large language model 240. The lineage information obtained by the lineage tracking module 250 includes a data source of at least one upstream data that generates the target data and at least one service that generate the target data or the upstream data. The data source usually refers to a device, a database or a file for storing data, such as a name, identification data or a network address of the device, a name or identification data of the database, or a file name; however, the present invention is not limited to above-mentioned examples. For example, the lineage tracking module 250 can look up the data source of the upstream data of the target data from a pre-built field correspondence table through the field information (and the dashboard name) of the target data. Alternatively, the lineage tracking module 250 can also query the service correspondence table to find a service name or service identification data of the service generating the target data based on upstream data or the service recording a relationship between the source data and the result data.

The lineage tracking module 250 is also configured to obtain the lineage data related to the target data based on the obtained lineage information. For example, the lineage tracking module 250 generates a node query sentence based on the data source of the upstream data of the target data in the obtained lineage information and executes the generated node query sentence to read the upstream data related to the target data from one or more upstream data repository. The lineage tracking module 250 can query, from the system logs, whether the service that generates upstream data of target data operates normally based on the service name or service identification data of the service generating the upstream data of the target data in the obtained lineage information.

In some embodiments, the lineage tracking module 250 obtains the lineage information of the target data and the lineage data related to the target data through the query tool 260. The lineage tracking module 250 can also obtain the lineage information and the lineage data directly using the same method as the query tool 260, but the present invention does not have specific limitation in the manner of obtaining the lineage information and the lineage data.

The query tool 260 can also obtain the field information acquired by the lineage tracking module 250 and generate the lineage information of the target data based on the obtained field information. For example, the query tool 260 obtains the lineage table and queries the lineage information from the lineage table based on a name or identification data of a product, a name or identification data of a station, a name or identification data of a component, a field name in the field information; however, the present invention is not limited to above-mentioned examples. The query tool 260 can read the lineage table from the storage medium 140 or download the lineage table from the network device or management device on the production line via the communication interface 130.

The query tool 260 generates the node query sentence corresponding to different data sources based on the generated lineage information, and reads the upstream data associated with the target data from the data source based on the generated node query sentence. For example, the query tool 260 can execute the node query sentence to obtain the upstream data. The aforementioned data sources can include one or more upstream data repository, such as a data warehouse (DW), a data mart (DM), an operational data store (ODS), and a raw database, but the present invention is not limited to above-mentioned examples. For example, the query tool 260 can generate the node query sentences corresponding to different data sources based on different data sources of the upstream data for the target data, respectively. For example, in an embodiment, in a condition that the field name of the data field of the target data is “assettag”, when the query tool 260 needs to query the upstream data from a data warehouse, the query tool 260 generates the node query sentence “Select assettag From dw.fact_product_sn Where sno=‘SH0123456789’ ”, and when the query tool 260 needs to query the upstream data from the operational data store, the query tool 260 can generate the node query sentence “Select assettag From ods. sno Where sno=‘SH0123456789’”, and when the query tool 260 needs to query the upstream data from a data mart or raw database, the query tool 260 can generate a similar node query sentence, and when the query tool 260 needs to query the upstream data from the data generation layer, the query tool 260 can generate the node query sentence “Select data->custattribute->assettag As assettag From product_stream Where data->sn=‘SH0123456789’”. However, the present invention is not limited to above-mentioned examples.

The query tool 260 can also detect the service generating the upstream data to generate a service detection result corresponding to each detected service. The service can include, but not limited to, an extract-transform-load (ETL) function in a database and a cloud synchronization storage service.

The abnormality locating module 270 is configured to compare whether the upstream data obtained by the lineage tracking module 250 matches the target data, determines whether the service generating the upstream data is normal based on the service detection result obtained by the lineage tracking module 250, and generates the discrepancy information based on whether the upstream data matches the target data and whether the service generating the upstream data operates normally. The discrepancy information includes data sources of the upstream data not matching the target data and the name of the service generating the abnormal upstream data.

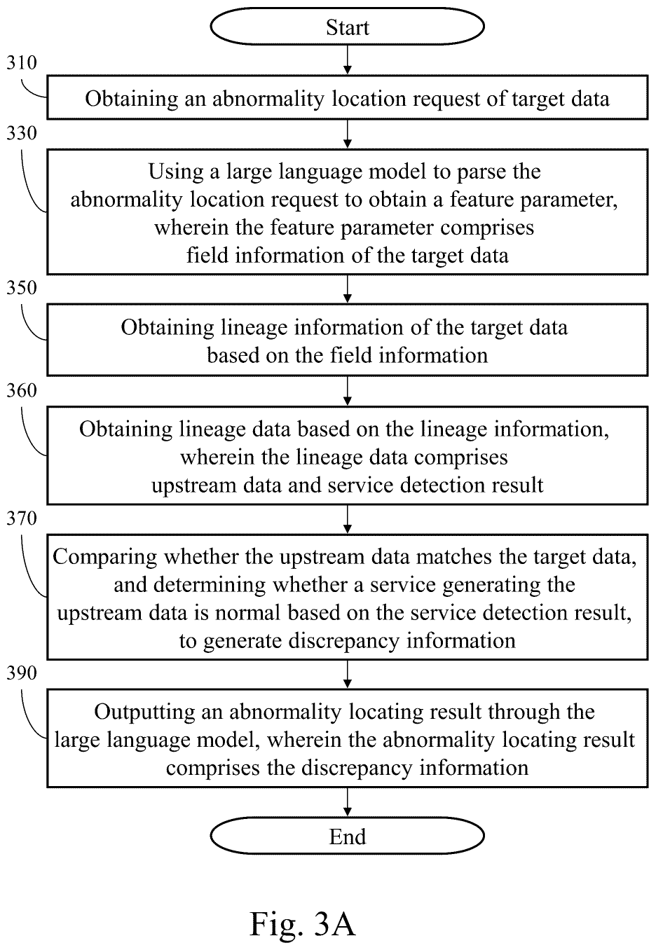

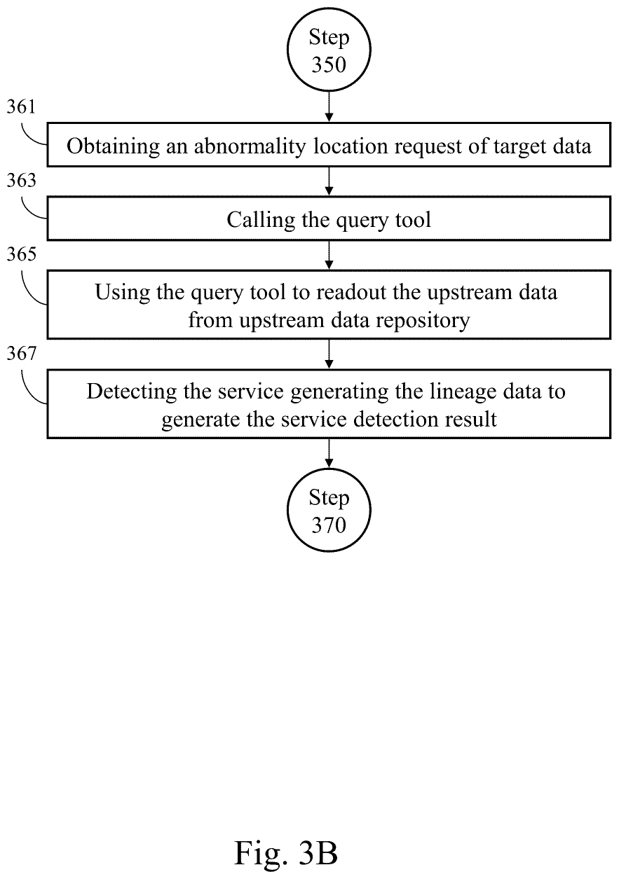

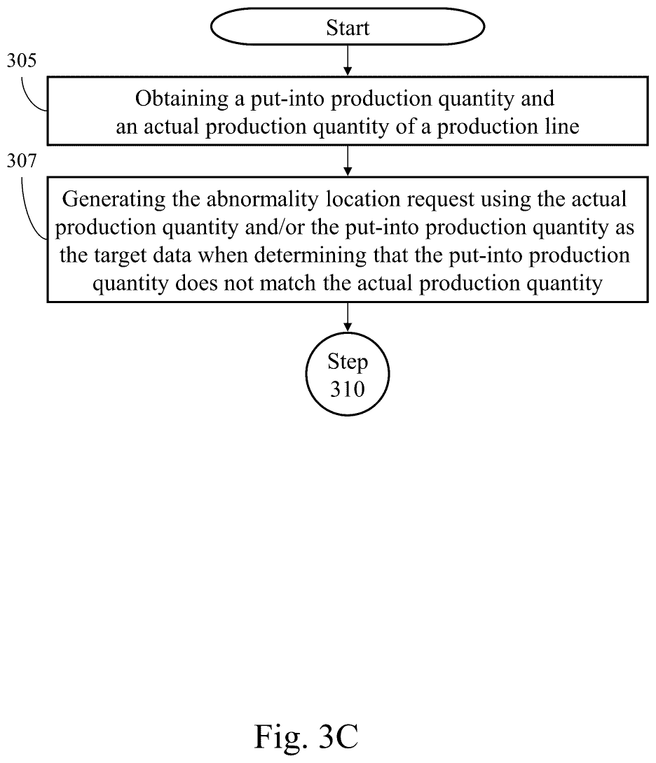

An embodiment is illustrated to explain the system operation and method of the invention. Please refer to FIG. 3A, which is a flowchart of a method of checking lineage of data with a large language model to locate abnormalities, according to the present invention. In this embodiment, the device 100 operates on the production line.

In a step 310, the request obtaining module 230 of the device 100 continuously detects the occurrence of the abnormality location request. When the abnormality location request occurs, the request obtaining module 230 obtains the abnormality location request. In this embodiment, the production line engineers can continuously monitor visual dashboards on the production line to track order completion status. When engineers find an abnormal event in the actual production quantity and the put-into production quantity on the production line, they can contact maintenance personnel via SMS or phone. When receiving notifications, the maintenance personnel, can write the abnormality location request in natural language containing the name or identification data of the dashboard on the production line where abnormality occurs and the abnormal data (that is, the target data) on the dashboard on the production line where abnormality occurs. The abnormality location request is transmitted to the device 100, so that the request obtaining module 230 of the device 100 can receive the abnormality location request received by the communication interface 130.

In a step 330, after the request obtaining module 230 of the device 100 receives the abnormality location request (step 310), the large language model 240 of the device 100 parses the abnormality location request to obtain the feature parameter. In this embodiment, the feature parameter can include a dashboard name and the station where the abnormality occurs.

In a step 350, after the large language model 240 of the device 100 obtains the feature parameter, the lineage tracking module 250 of the device 100 obtains the lineage information of the target data based on the field information in the feature parameter. In this embodiment, the large language model 240 can call the lineage tracking module 250 and transmit the field information as a parameter to the lineage tracking module 250 while calling, so that the lineage tracking module 250 can query the lineage information of the target data based on the field information.

In a step 360, after the lineage tracking module 250 of the device 100 obtains the lineage information of the target data, the lineage tracking module 250 can obtain the lineage data related to the target data based on the lineage information. In this embodiment, as shown in the flowchart of FIG. 3B, in a step 361, when the lineage data includes an upstream data source (i.e., a name of an upstream data repository) and a name of the ETL function for the upstream data source, the lineage tracking module 250 can generate the node query sentence corresponding to one or more upstream data repository based on the upstream data source. In a step 363, the lineage tracking module 250 can call the query tool 260. In a step 365, the query tool 260 can query corresponding upstream data from the corresponding upstream data repository based on the node query sentence. In a step 367, the query tool 260 can detect the service (i.e., the ETL function) generating the upstream data to generate the service detection result.

Please refer to FIG. 3A. in a step 370, after the lineage tracking module 250 of the device 100 obtains the lineage data related to the target data, the abnormality locating module 270 of the device 100 compares whether the upstream data in the lineage data matches the target data, and determines whether the service generating the upstream data is normal based on the service detection result in the lineage data, to generate the discrepancy information. In this embodiment, the lineage tracking module 250 transmits the obtained lineage data to the large language model 240 of the device 100, the large language model 240 can call the abnormality locating module 270 and provide the lineage data as a parameter to call the abnormality locating module 270, so that the abnormality locating module 270 can compare whether the upstream data in the lineage data matches the target data, and determines whether the service generating the upstream data is normal based on the service detection result in the lineage data. Therefore, the abnormality locating module 270 generates the discrepancy information.

In a step 390, after the abnormality locating module 270 of the device 100 generates the discrepancy information, the large language model of the device outputs the abnormality locating result containing the discrepancy information. In this embodiment, the abnormality locating module 270 provides the generated discrepancy information to the large language model 240, so that the large language model can generate the abnormality locating result in natural language containing the semantics of the discrepancy information, and the abnormality locating result can be displayed through the output unit 150 of the device 100 for maintenance personnel.

Through the solution of the present invention, maintenance personnel can generate the abnormality location request for the large language model in natural language, to enable the large language model to generate the abnormality locating result in natural language, so that the maintenance personnel can intuitively understand the part where abnormality occurs.

In the above embodiment, the device 100 can include an abnormality detection module 210 and a request generating module 220; as shown in the flowchart of FIG. 3C, in a step 305, before the request obtaining module 230 obtains the abnormality location request (step 310), the abnormality detection module 210 can be connected to the management device on the production line via the communication interface 130 of the device 100 to download data from visualization dashboards on the production line, thereby obtaining the put-into production quantity and the actual production quantity on the production line. In a step 307, the abnormality detection module 210 can determine whether the put-into production quantity matches the actual production quantity, when the abnormality detection module 210 determines that the put-into production quantity does not match the actual production quantity, the request generating module 220 generates the abnormality location request with the actual production quantity and/or the put-into production quantity as the target data. In a step 310, the request generating module 220 can provide the generated abnormality location request to the request obtaining module 230, so that the request obtaining module 230 can obtain the abnormality location request.

According to above-mentioned contents, the difference between the present invention and the conventional technology is that, in the present invention, the large language model is used to parse the abnormality location request in natural language to obtain field information of target data occurring abnormality, lineage data of the target data is obtained based on the field information to generate discrepancy information indicating the upstream data and/or service where abnormality is occurred, and the large language model outputs the abnormality locating result of the discrepancy information in natural language. Therefore, the above-mentioned technical solution of the present invention can solve the conventional problem of high complexity, high time costs, low efficiency, and dependence on personnel experience in the abnormality check process on a production line, and achieve the technical effect of improving inspection efficiency and accuracy and user satisfaction.

Furthermore, the method of checking lineage of data with a large language model to locate abnormalities of the present invention can be implemented by hardware, software or a combination thereof, and can be implemented in a computer system by a centralization manner, or by a distribution manner of different components distributed in several interconnected computer systems.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of checking lineage of data with a large language model to locate abnormalities, applied to a device or a system, and comprising:
obtaining an abnormality location request of target data;
using a large language model to parse the abnormality location request to obtain a feature parameter, wherein the feature parameter comprises field information of the target data;
obtaining lineage information of the target data based on the field information;
obtaining lineage data based on the lineage information, wherein the lineage data comprises at least one upstream data and at least one service detection result;
comparing whether the at least one upstream data matches the target data, and determining whether at least one service generating the at least one upstream data is normal based on the at least one service detection result, to generate discrepancy information; and
outputting an abnormality locating result through the large language model, wherein the abnormality locating result comprises the discrepancy information.

2. The method of checking lineage of data with a large language model to locate abnormalities according to claim 1, wherein the step of obtaining the lineage information of the target data based on the field information, comprises:
using the field information as an input parameter to a query tool, calling the query tool, and using the query tool to generate the lineage information of the target data.

3. The method of checking lineage of data with a large language model to locate abnormalities according to claim 1, wherein the step of obtaining the lineage data based on the lineage information comprises:
generating a node query sentence based on the lineage information, using the large language model to call a query tool based on the node query sentence, using the query tool to readout the upstream data from at least one upstream data repository and detect the service generating the lineage data to generate the at least one service detection result.

4. The method of checking lineage of data with a large language model to locate abnormalities according to claim 1, wherein the step of outputting the abnormality locating result through the large language model, comprises:
generating the abnormality locating result expressing the discrepancy information by natural language.

5. The method of checking lineage of data with a large language model to locate abnormalities according to claim 1, wherein before the step of obtaining the abnormality location request of the target data, further comprising:
obtaining a put-into production quantity and an actual production quantity of a production line, and generating the abnormality location request using any combination of the actual production quantity and the put-into production quantity as the target data when determining that the put-into production quantity does not match the actual production quantity.

6. A device of checking lineage of data with a large language model to locate abnormalities, comprising:
a memory, configured to store at least one computer instruction; and
a processor, connected to the memory and configured to execute the at least one computer instruction to generate:
a request obtaining module, configured to obtain an abnormality location request of target data;
a large language model, configured to parse the abnormality location request to obtain a feature parameter, wherein the feature parameter comprises field information of the target data;
a lineage tracking module, configured to obtain lineage information of the target data based on the field information, and obtain lineage data based on the lineage information, wherein the lineage data comprises at least one upstream data and at least one service detection result; and
an abnormality locating module, configured to compare whether the at least one upstream data matches the target data, and determine whether the service generating the at least one upstream data is normal based on the at least one service detection result, to generate discrepancy information, wherein the large language model generates and outputs an abnormality locating result, and the abnormality locating result comprises the discrepancy information.

7. The device of checking lineage of data with a large language model to locate abnormalities according to claim 6, wherein the processor further generates a query tool configured to generate the lineage information of the target data based on the field information provided by the lineage tracking module.

8. The device of checking lineage of data with a large language model to locate abnormalities according to claim 6, wherein the processor further generates a query tool configured to read the at least one upstream data from at least one upstream data repository based on a node query sentence, which is generated by the lineage tracking module based on the lineage information, to detect the service generating the at least one upstream data to generate the at least one service detection result.

9. The device of checking lineage of data with a large language model to locate abnormalities according to claim 6, wherein the large language model generates the abnormality locating result expressing the discrepancy information by natural language.

10. The device of checking lineage of data with a large language model to locate abnormalities according to claim 6, wherein the processor further generates an abnormality detection module and a request generating module, wherein the abnormality detection module is configured to obtain a put-into production quantity and an actual production quantity of a production line, and determine whether the put-into production quantity matches the actual production quantity, and when the abnormality detection module determines that the put-into production quantity does not match the actual production quantity, the request generating module generates the abnormality location request using the actual production quantity and/or the put-into production quantity as the target data.
